(19) United States
(12) Patent Application Publication
(10) Pub. No.: US 2010/0276437 A1
(43) Pub. Date: Nov. 4, 2010

(54) CONTAINER HAVING A CLOSURE COMBINATION OF A LID RING IN THE MANNER OF A PRESS-IN LID AND RESEALABLE CAP

(75) Inventors: Birger Keilberg, Seesen (DE); Winfried Spickermann, Hahausen (DE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Impress Metal Packaging SA, Crosmieres - La Fleche Cedex (FR)

(21) Appl. No.: 12/293,717

(22) PCT Filed: Mar. 20, 2007
(86) PCT No.: PCT/EP07/52667

§ 371 Date: May 24, 2010

(30) Foreign Application Priority Data
Mar. 21, 2006 (DE) 10 2006 013 247.5
May 5, 2006 (DE) 10 2006 021 079.4

(51) Int. Cl. B65D 41/16; B23P 17/04; B65B 1/04

(52) U.S. Cl. 220/780; 29/428; 141/1

(57) ABSTRACT

A container is formed, in which firstly a contained fluid is protected by the packaging, which corresponds to dangerous medium requirements and, with a simple configuration of the closure combination, first closure of the filled container and easy opening and resealing may be achieved. To this end, a container is structured having a press-in lid which serves for first closure. It has a lid ring having a film which is fastened to it in a fluidtight manner and closes an opening which is delimited on the inside by the lid ring. A lid cap which serves to reseal the container is provided. The first closure means and the resealing means can be moved into a tightly sealing position during first closure of the filled container by means of pressure in the direction of one axis of the container, optionally individually or, if preassembled to form one unit, together.

### CROSS-REFERENCE TO RELATED APPLICATIONS

This application is the U.S. National Stage filing of International Application No. PCT/EP07/52667, filed Mar. 20, 2007, which claims priority to German Patent Application No. 10 2006 013 247.5, filed Mar. 21, 2006, and German Patent Application No. 10 2006 021 079.4, filed May 5, 2006, the disclosures of which are hereby incorporated by reference.

### FIELD OF THE INVENTION

The invention relates to a container, in particular in the form of a cylindrical paint can or another can for filling in chemical-technical fluids, comprising a cover combination serving for the initial closing and, after the container has been opened for the first time, is for resealing it.

### BACKGROUND OF THE INVENTION

Press-in lid packaging for paint cans is generally known. It comprises a lid ring which is open on the inside and which is closed with the press-in lid. Using a screwdriver as a lever, a handyman can get access to the paint. This handling should be made easier and is to be improved with respect to the risk of injury.

GB-A 1 519 939 discloses a cover for containers not made of sheet metal, the open body end of which has an edge which has not been shaped so that this edge has to be inserted into the circumferential channel/groove 18 of a plastic beaded ring (there “sealing ring” 12 in the English description) and has to be attached to it fixedly and permanently by sealing. This beaded ring 12 and its tight sealing with the unshaped body edge of the container (which, at the most, has been slightly widened only during inserting into the groove 18 according to FIG. 3) is a prerequisite that the cap 16 will be retained well on the container after pressing on axially by means of the inner lip 34 under tension reaching behind the outer part 28 of the beaded ring 12 (see FIGS. 2 to 4). Thus the beaded ring 12 replaces the shaped upper body edge commonly found in metal containers. The lid disk 14 (see page 3, line 36) is detachably sealed onto the top 20 of the beaded ring 12 or may be connected to the sealing cap 16 (inner face) in such a way that it can be removed together with the cap 16 from the container, page 2, lines 88. As can be seen from page 3, line 37, the beaded ring 12 does not correspond to a “press-in lid” and actually not to a lid ring. The beaded ring is slipped on to the unshaped end of the container body with its groove 18. Then the plate 14 is heated and welded under pressure onto the cap 16 on the top 20 of the beaded ring. In the same manner and, if applicable, simultaneously the beaded ring is welded to the body wall, as described at page 3, lines 64 to 79 and also at page 3, lines 9 to 13. In its slipped-on state the surfaces of the body wall and the beaded ring fit closely under slight tension in the area of the groove 18 when the body edge is slightly widened upon insertion. This tension is supposed to facilitate the heat sealing of the surfaces to each other (see page 3, lines 30-35). The references in the preceding paragraph refer to GB-A 1 519 939.

EP-A 1 561 696 is directed to a special form of a sealing cap which, while a sealing film covering the entire container opening is put in between, is able to assume two closing positions in co-operation with a body edge rolled radially outward: a first position, in which the cap keeps the film under tension in a sealing manner on the rolled-up edge, and the second position, in which, after removing the film, the bottom of the cap itself sits under tension on the rolled-up portion in a sealing manner.

U.S. Pat. No. 5,174,464 also provides a lid ring 16 which, however, is connected to the edge of the container body by means of an edge-formed seam 18 in a mechanically fixed and permanent manner (see column 3, lines 19). Reference 20 does not indicate a “locking bead” in the area of the lid ring extending parallel to the container axis, but an annular groove 20 in the flange of the lid ring extending in radial direction to the container axis. A corresponding annular groove 36 of the lid part engages the annular groove of the beaded ring in a tight fit from the top while sealing material provides for an appropriate sealing at two locations. The cap 48 keeps the parts mentioned in engagement and is additionally secured by adhesive tape. Co-operating locking beads and counter beads in the circumferential area of the container and the lid ring are not mentioned. The references in the preceding paragraph refer to U.S. Pat. No. 5,174,464.

### SUMMARY OF THE INVENTION

Exemplary embodiments provide a container of the above-mentioned type in which a filled-in fluid is sufficiently protected by the packaging, which corresponds to the requirements for dangerous media, and which allows for an easy initial sealing of the filled container as well as for an easy opening and resealing using simple means.

Exemplary embodiments provide a special press-in lid for initial sealing of a fluid container or can. This lid includes the lid ring cooperating with the edge of the can body and a film tightly sealing its central opening, which can be pushed in or pulled off the lid ring for initial opening. For resealing the open container, a lid cap is used that has an annular collar which extends from its bottom in axial and radial direction and which cooperates with the container edge in a sealing manner under pre-stress.

Both the lid ring and the lid cap are to the considered as disclosed independently in addition to their combination as a dual cover.

According to exemplary embodiments, a lid ring (of the type of a press-in lid) and a cap each lock directly and separately onto the correspondingly rolled-up top end of the container in a sealing manner. Their support and their sealing effect are independent of each other.

The arrangement according to exemplary embodiments ensures that the both the press-in lid serving for the initial closing and the lid cap serving for resealing the open container can be locked separately, directly onto the edge portion of the container body in a secure and sealing manner such that they separately provide a secure sealing of the fluid in the container.

This sealing combination has a simple structure and can be easily manufactured. The press-on lid is provided with a special lid ring (of the press-in lid type) which includes, as commonly known, a shaped top edge, a radially extending bottom flange for attaching the margin of the film, and a portion connecting both parts and extending in the direction of the container axis, but the id ring is different from the commonly known type in that its top edge is not formed for a beading flange connection to the top edge of the can body, and its intermediate portion has one or more circumferential locking beads exactly matched to position and shape of counter beads in the body below the top edge of the body, which at the same time guarantees sealing and keep the top edge portion of the lid ring under pre-stress in sealing contact to the top edge of the body. While the press-in lid comes into locking engagement with the body wall from the inside, as described, the lid cap locks with the correspondingly shaped top edge of the body under sealing pre-stress from the outside. Also the lid cap has a simple shape which promotes ease of manufacture.

Both parts, the lid cap and the lid ring, may be brought into their closing position separately or pre-assembled as a unit by means of simple pressing in the direction of the container axis. The initial opening of the container by pulling off or breaking the closing film and re-opening by detaching the lid cap can be easily performed.

In exemplary embodiments, for initially closing the press-in lid, as well as the lid cap, both can be brought into their respective sealing and secure position on the container body solely by exerting axial pressure onto these elements. To this end simple and often already existent devices can be used. Both closing elements can each be entirely preformed since they have to undergo no further working or shaping process for them to be sealingly mounted on the container.

Both closing elements may be pre-assembled as a unit before they are pressed onto the filled container for initially closing it. For opening it is not necessary to remove the novel press-in lid. The user opens the film.

The edge area may be the actual top edge and at a distance thereto at least one locking bead which may be provided and extended in form of a labyrinth seal.

Through the arrangement of the seal combination the original condition may be guaranteed without additional measures. A broken film over the inner opening of the lid ring is a visible indication that the contents of the container have been touched. This broken state of a substantially flat, very thin and easily visible film is easily recognized when viewing it, even in an inclined state. Even the smallest cracks of this film may be possibly seen immediately with the naked eye.

The safeguarding position in the closed state is to be mentioned, in which a kind of labyrinth seal between beads and counter beads is generated which lies below the top edge in the top edge area and is provided in the axial transition region between the horizontal flange and the outer edge of the lid ring. These—preferably multiple—locking beads on the side of the container body and counter beads on the side of the lid ring provide a seal in addition to their retaining effect.

The retaining effect provides a pre-stress at the sealing edge. A pre-stress in the connecting area between the film and the horizontal flange of the lid ring may come into existence additionally or may be separately present. A pressing element causes this pre-stress in the sense of a force supporting the sealing of the film. The pressing element used may be circumferential and may be embodied in an annular shape for a circular or cylindrical container.

For blocking possible diffusion of a chemically aggressive fluid filling through the plastic, an additional thin foil may be provided in or laid into the lid cap such that it covers the panel or flat area substantially completely and also covers the pressing element at least at its side.

This barrier foil may serve to block the diffusion of evaporating solvents. The foil may be made of metal, such as aluminum, wherein such a “thin foil” may have a maximum thickness below 50 μm.

As an alternative embodiment, a coating, also consisting of a metal, may be deposited by evaporation on the inner face of the lid cap. Further alternatives such as a diffusion barrier may be used. Sprayed-on sol-gel coatings may also serve as a diffusion barrier.

In the following, the invention will be described in more detail on the basis of several exemplary embodiments with reference to the schematic drawings.

### BRIEF DESCRIPTION OF THE DRAWINGS

FIG. 1 shows a cross section of a detail of an exemplary embodiment of the seal combination in position on a container after initial closing.

FIGS. 2a,2b, and 2c show a container and the two corresponding seal elements separately and in cross section.

FIG. 3 shows an embodiment according to FIG. 1 which is modified by additionally providing a diffusion barrier 60 which is attached in the lid cap 15 in the form of a thin foil.

### DETAILED DESCRIPTION OF THE PREFERRED EMBODIMENTS

The “can” described in the embodiments is meant to represent a container in a general form without limitations with respect to its cross-sectional shape and its filling volume. The container is preferably developed for containing chemical technical fluids. For example, the can may contain paint as well as other types of solvents. When a can is described in the following, such as a can for containing paint in the sense of a paint can, this is to be understood as a non-limiting example only.

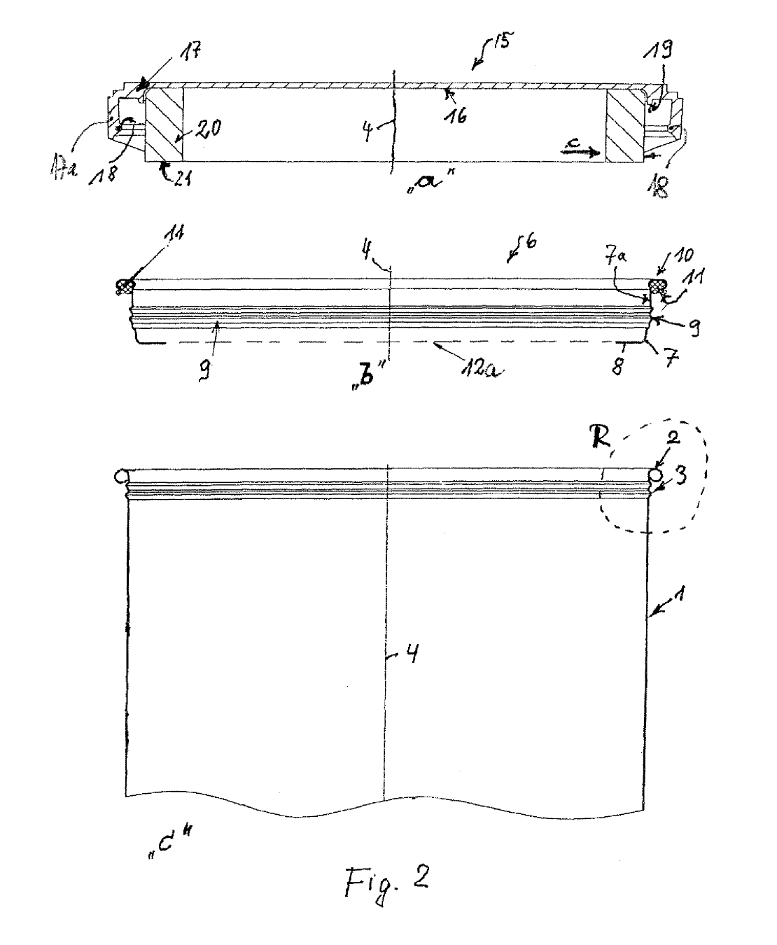

Section “c” of FIG. 2 shows a container 1 with a container axis 4. The edge 2 of the container opening is rolled-up radially outward. Below the rolled-up portion the container wall has at least one circumferential bead 3 and preferably multiple beads arranged axially at a distance.

Preferably two or more such beads are provided one below the other and close to each other.

The press-in lid 6 for initially closing the filled can is shown in section “b” of FIG. 2. It includes a lid ring 7 having an outwardly bent edge 10 (radially in the sense of “outward”) to be put on the outer rolled-up portion of the edge. In an embodiment the edge may lie directly on the rolled-up portion 2 under pre-stress in the closing position. As shown in FIG. 2b, it may also receive a sealing element 11 which in this case lies on the rolled-up edge under pre-stress.

The lid ring 7 has a strip-shaped flange 8 extending radially inward at an axial distance from the edge 10, and on said flange the margin of a film 12 is laid and tightly attached, for example by means of a sealing seam, which film covers the inner opening 12a of the lid ring defined by said flange. This is designated as connecting area V.

The inner edge of the flange 8 may be rolled up downward-outward or upward-outward to avoid an open edge of cut. This feature is not illustrated, but can be easily imagined by one of ordinary skill in the art.

For initial opening (such as opening for the first time) the film 12 may broken or pulled off. The cylindrical connecting wall 7a between the flange 8 and the edge 10 of the lid ring is shaped in the form of circumferential locking elements 9 as counter beads at a matched axial distance from the edge 10, which beads are matched in their number, shape, and arrangement in such a way to the number, position, and shape of circumferential locking beads 3 that when pressing the lid 6 onto the can a resilient locking engagement and preferably simultaneously a kind of labyrinth seal is formed in this area. This is part of the upper edge portion R.

Moreover, taking into consideration an exemplary sealing element 11 in the outer edge, this locking arrangement is matched to the top edge 2 of the can as well as the outer edge 10 of the lid ring in such a way that these sealingly lie upon each other in the closing position under pre-stress.

A sealing element may be an annular compound clamped into the edge 10.

The press-in lid 6 can be completely produced by the can manufacturer in a separate process and pressed on axially in a simple working step after filling the container in the filling plant, thus achieving a secure connection and a reliable sealing at the edge. No fluid can leak out of the closed container and the product is entirely secured. The film, the connection, and the labyrinth seal are at least fluid tight.

FIG. 2a shows the accompanying cover for resealing in the form of a lid cap 15. It is fabricated in one piece from plastic and may not only be supplied together with the press-in lid 6, also the parts may be supplied in a pre-assembled state, but may also have been pressed or be pressed onto the filled can for initial closing thereof.

The lid cap has a preferably flat central area which integrally merges with a profiled cap edge area 17. Compared to the central area 16 it is formed from material having a substantially thicker cross section to achieve a secure resilient but also sealing support in its area of engagement with the edges 10 of the press-in lid 6 and 2 in its resealing position.

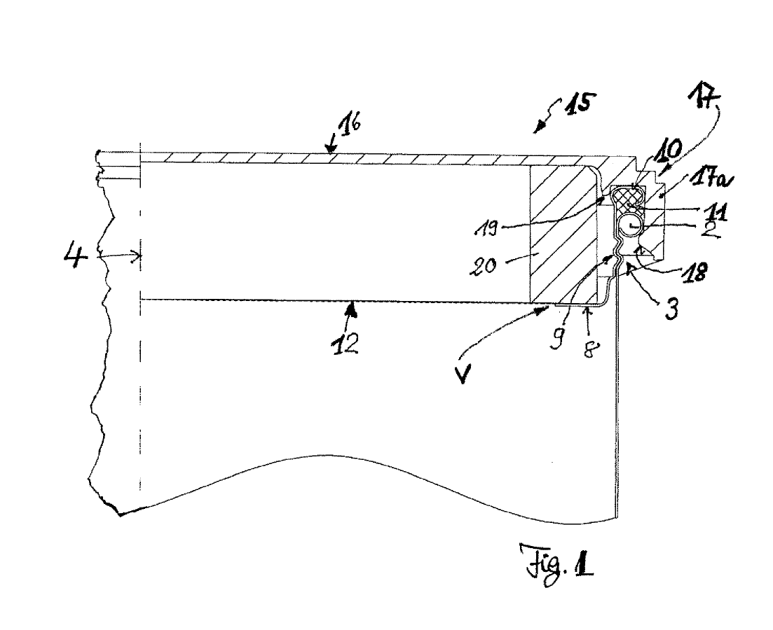

In the inner upper area between the portion 17a (a skirt) at the side of the edge and a circumferential axial projection 19 arranged radially in front thereof, there is defined a recess for lying on and reaching behind the edge 10 of the press-in lid 6, as can be clearly seen in FIG. 1 showing the engagement position.

The portion 17a extends axially further downward and comprises at a distance to its lower edge an inner circumferential locking bead or several locking beads 18 distributed in circumferential direction.

The arrangement is configured such that the profiled edge area 17 has a collar 17, 18, 19 in its closing position that reaches around the press-in lid 6 in its closed position and the edge area 2 of the can 1 and, with its at least one locking bead 18, reaches below it. The edge bead 10 can be loaded with an additional axial pre-stress; it is however preferred to exert pressure on the connecting area V, as will be described. The lid cap 15 may be simply pressed on by axial pressure, also in a pre-assembled state together with the press-in lid 6. By locally expanding (such as pulling off) the skirt portion 17a may be removed just as simply.

To protect the can and its cover against unintentional opening caused by falling before the initial opening, an annular pressing element 20 can be inserted into the interior of the lid cap or can be molded thereto in one piece. Its dimension “c” is matched in such a way to the cover combination that over the central area of the lid cap 15 and the pressing element 20 with its preferably annular flat bottom face 21 an axial elastic pressure is exerted on the connecting area V between the flange 8 of the lid ring 7 and the sealing film 12 in a yet unopened state, which pressure keeps the connecting area V biased in axial direction. In this way the sealing area at the flange 8 may be supported.

Preferably the radial width c of the pressing element 20 is chosen such that it projects radially inward beyond the inner edge of the flange 8, as shown in FIG. 1, thus protecting the film in the area of that inner edge (or inner rolled-up portion) against destructive loads. Thus, even in the event of a substantial fall, the can and its cover may remain undamaged and reliably tightly sealed.

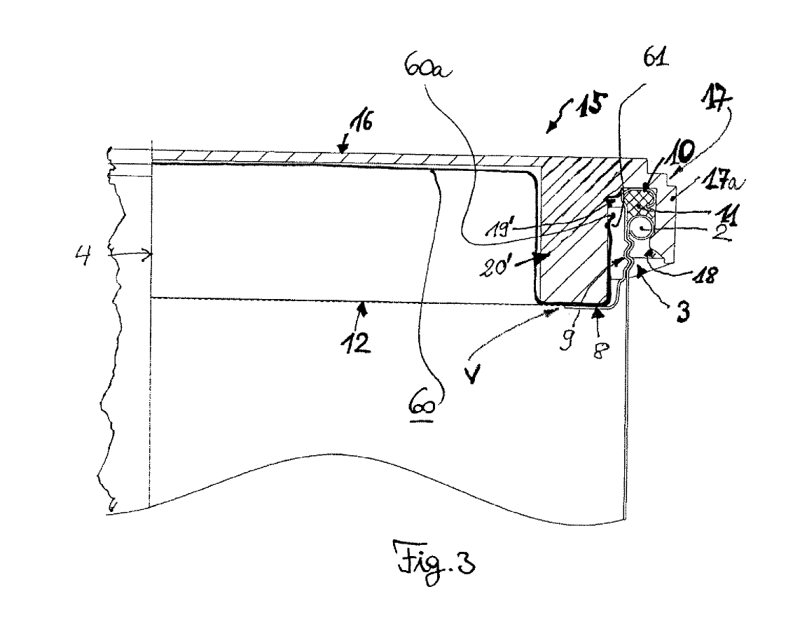

FIG. 3 is the embodiment of FIG. 1 to which reference is made in its entirety. Additionally, in the central area 16 of the plastic lid cap 15 a thin foil designated with reference numeral 60 is inserted. It meanders along the inward facing surface, covering the entire central area 16 and also adapting itself vertically to the pressing element 20 which has an annular shape in this example. This diffusion barrier 60 is provided as well at the bottom face 21 acting as a pressure face for applying elastically resilient force to the connecting area V.

It further extends outward beyond the connecting area V between film 12 and flange 8 and may be attached to a vertical wall, for example a radial outer wall of the pressing element 20, by means of a circumferential bonding portion. This bonding portion 61 is provided shortly before the outer end 60a of the foil 60.

In another exemplary embodiment (not shown), this foil 60 may extend into the edge area 17 of the cap to lie at or on the bead 2 or 10 in a sealing manner when the lid cap 15 performs resealing or the lid ring 7 securing the initial closing has been opened or no longer exists. When the foil 60 reaches into the sealing area which also provides the frictional connection for securing the lid cap, the entire area may be covered in the axially upward direction by a diffusion barrier 60 which may provide a diffusion barrier also against chemically aggressive vapors.

Embodiments not shown which are configured according to FIG. 3, comprise vapor-deposited diffusion barriers or sprayed-on sol-gel coatings having a corresponding effect. They replace the foil 60.

A minimum dimension may be to be chosen for the thickness of these layers or foil, which is preferably below 50 μm with respect to the foil 60, according to exemplary embodiments. With specific vapor-deposited coatings, also if made of metal, even thinner layers are possible. As an exemplary foil 60 a kind of metallic foil, particularly made of thin aluminum, may be provided.

1. A container, for fluids, comprising:
a press-in lid configured for forming an initial seal and comprising:
a lid ring with a film attached fixedly and tightly, said film closing an opening defined by the lid ring,
and a lid cap configured to reseal the container, wherein
the initial seal and the lid cap for resealing can be brought into a tightly sealed position by means of pressure in the direction of an axis of the container either each individually or together as a pre-assembled unit when initially closing the filled container.

2. A container for fluids comprising:
a press-in lid configured for forming an initial seal, comprising:
a lid ring capable of being locked by means of pressure, in the direction of the axis with an upper edge area, in a snap-on and sealing manner and which is sealingly connected to a film closing a take-out opening, and comprising:
a lid cap configured to reseal an opened container which can be locked by means of pressure in the direction of the axis with an upper edge of the upper edge area in a snap-on and sealing manner.

3. The container according to claim 1, wherein a top edge has a bead projecting radially outward and the lid cap comprises a collar which, in the closing position, under pre-stress, reaches over the bead and at least, in sections, under it.

4. The container according to claim 1, wherein, in the lid cap, a diffusion barrier is located and comprises a foil layer.

5. The container according to claim 1, wherein a body comprises one or more circumferential locking beads at a distance from a top opening edge, to which are assigned correspondingly shaped circumferential counter beads in the transition area extending in the direction of the axis between an outer edge and a radially inner flange of the lid ring forming a connecting surface for the film.

6. The container according to claim 2, wherein a body comprises an edge bead in the upper edge area and at a distance thereto at least one circumferential locking bead to which is assigned at least one correspondingly shaped circumferential counter bead in a transition area extending in the direction of the axis between an outer edge and a radially inner flange of the lid ring forming a connecting surface for the film.

7. The container according to claim 5, wherein the outer edge of the lid ring is bent outwardly and, in particular receiving a sealing ring, shaped for sealing engagement with the top opening edge of the body under axial pre-stress in an engagement position of the counter beads of the lid ring with the locking beads of the body.

8. The container according to claim 3, wherein the collar of the lid cap is configured on its inner face to provide additional axial pre-stress for an outer edge of the lid ring in its sealing position on the top edge.

9. The container according to claim 1, wherein an axial pre-stress is exerted on a top side of a flange in the sealing position with a pressing element by means of pressure on the flange and the film together.

10. The container according to claim 1, wherein during initial sealing of a filled container a circumferential, in particular, an annular pressing element, can be inserted into the lid cap or is molded thereto in one piece.

11. The container according to claim 1, wherein an outer diameter of a pressing element is substantially equal to a smallest inner diameter of a collar.

12. The container according to claim 1, wherein a radial width of a pressing element is at least equal to a radial extension of a flange of the lid ring.

13. The container according to claim 1, wherein an axial height of a pressing element is larger than the clear distance as measured in an axial direction between a bottom of an inner area and a top of a flange in an unstressed condition.

14. The container according to claim 1, wherein when initially sealing a filled container, a circumferential, annular pressing element can be inserted into the lid cap or is molded thereto in a material bonding manner, that has an outer diameter which is substantially equal to a smallest inner diameter of a collar, a radial width which is substantially equal to a radial extension of a flange of the lid ring, and an axial height which is larger than the clear distance between a bottom of a central part of the lid cap and a top of the flange in the sealing position to such an extent that in the sealing position the pressing element exerts an axial pre-stressing pressure on the flange and the film, at least in a section of a connecting area.

15. A press-in lid container ring for fluid containers, comprising:
a lid ring and a film attached thereto in a fluid-tight manner closing an inner opening defined by the lid ring, and capable of receiving a lid cap configured for resealing a container,
wherein the film lid ring serves as an initial seal for initial sealing and can be pressed in by means of pressure in the direction of an axis of the container into a position in which a radially outward situated lid ring edge engages a container edge for sealingly closing the container;
wherein the lid ring edge is not suitable for tacking or a tacked seam.

16. The press-in lid container ring according to claim 15, wherein the lid ring comprises a lid ring edge which can be locked in a snap-on and sealing manner with a top edge area of the container by pressure in the direction of the axis.

17. The press-in lid container ring according to claim 15, wherein a strip-shaped and radially inward extending flange is provided which has an axial distance from a lid ring edge and onto which the film is laid over and attached to in a sealing manner.

18. The container according to claim 15, wherein the lid ring in combination with the film closes a take-out opening, and is suitable for sealingly closing a chemical-technical filling fluid container.

19. A container ring lid cap for containers filled with fluids comprising:
a collar which can be locked in a snap-on and sealing manner with an edge area of the body by pressure in the direction of an axis, and the collar, for resealing an open container by means of the lid cap, can be locked in a snap-on and sealing manner by pressure in the direction of the axis in the edge area.

20. A container for fluids comprising:
two locking areas shaped at a top edge area of a body; a press-in lid serving for initial sealing, comprising:
a lid ring which can be locked by means of pressure in the direction of a container axis with one locking area of the two locking areas of the upper edge area of the body in a snap-on and sealing manner and which is sealingly connected to a film closing a take-out opening, and
a lid cap usable for resealing the container which has been opened for the first time by breaking or pulling off the film, which lid cap can be locked by means of pressure in the direction of the container axis with the second locking area of the locking areas of the upper edge area in a snap-on and sealing manner.

21. The container according to claim 20, wherein the top edge of the body has a bead projecting radially outward and the lid cap comprises a collar which, in the closing position, under pre-stress reaches over the bead and at least, in sections, under it.

22. The container according to claim 20, wherein, in the lid cap, a diffusion barrier is arranged, particularly in the form of a foil layer.

23. The container according to claim 20, wherein the body comprises one or more circumferential locking beads at a distance from the upper opening edge and the lid ring comprises in its transition area, which extends in the direction of the container axis between its outer edge and the radially inner flange forming the connecting surface for the film, circumferential counter beads shaped and positioned corresponding to the one or more locking beads.

24. The container according to claim 23, wherein the outer edge of the lid ring is bent outwardly and, in particular receiving a sealing ring, is shaped for sealing engagement with an edge of the body under axial pre-stress in an engagement position of the counter beads of the lid ring with the locking beads of the body.

25. The container according to claim 22, wherein the collar the lid cap is configured on its inner face in such a way that it provides additional axial pre-stress for the outer edge of the lid ring in its sealing position on the container edge.

26. The container according to claim 20, wherein an axial pre-stress is exerted on a top side of the flange in the sealing position with a pressing element by means of pressure on flange and film together.

27. The container according to claim 20, wherein a circumferential, in particular annular pressing element is integrally molded onto the inner side of the preferably one-piece lid cap or can be inserted into the lid cap during initial sealing.

28. The container according to claim 26, wherein an outer diameter of the pressing element is substantially equal to the smallest inner diameter of the collar.

29. The container according to claim 26, wherein a radial width of the pressing element is substantially equal to a radial extension of the flange of the lid ring.

30. The container according to claim 26, wherein an axial height of the pressing element is larger than the clear distance as measured in axial direction between the bottom of the inner area of the lid cap and the top of the flange in an unstressed condition.

31. The container according to claim 20, wherein when initially sealing the filled container a circumferential, in particular annular pressing element can be inserted into the one-piece lid cap or is molded thereto in a material bonding manner, which element has an outer diameter which is about equal to the smallest inner diameter of the collar, a radial width which is at least equal to, preferably larger than the radial extension of the flange of the lid ring, and an axial height which is larger than the clear distance between the bottom of the central part of the lid cap and the top of the flange in the sealing position to such an extent that in the sealing position the pressing element exerts an axial pre-stressing pressure on the flange and the film, at least in a section of the connecting area.

32. A method for constructing a container to be filled with fluid, comprising:
sealing the container with a press-in lid configured for initial sealing that has a lid ring which locks with a top edge area in a snap-on and sealing manner by means of pressure in the direction of the axis;
sealingly connecting the lid ring to a film which closes its opening or take-out opening; and
resealing the container with a lid cap after opening, the lid cap locking with the top edge of the edge area in a snap-on and sealing manner by means of pressure in the direction of the axis.

33. A method for filling a container with a chemical-technical fluid, comprising:
sealing, initially, the container with a press-in lid comprising a lid ring sealingly connected with a film closing its inner opening or take-out opening,
wherein the lid ring has an outer edge area which locks with a top edge area of the container in a snap-on and sealing manner by means of pressure in the direction of the axis; and
resealing the container with a lid cap after opening, the lid cap locking with the top edge of the edge area in a snap-on and sealing manner by means of pressure in the direction of the axis.

34. The container according to claim 2, wherein a top edge has a bead projecting radially outward and the lid cap comprises a collar which, in the closing position, under pre-stress, reaches over the bead and at least, in sections, under it.

35. The container according to claim 2, wherein, in the lid cap, a diffusion barrier is located and comprises a foil layer.

36. The container according to claim 6, wherein the outer edge of the lid ring is bent outwardly and, in particular receiving a sealing ring, shaped for sealing engagement with the top opening edge of the body under axial pre-stress in an engagement position of the counter beads of the lid ring with the locking beads of the body.

37. The container according to claim 34, wherein the collar of the lid cap is configured on its inner face to provide additional axial pre-stress for an outer edge of the lid ring in its sealing position on the top edge.

38. The container according to claim 2, wherein an axial pre-stress is exerted on a top side of a flange in the sealing position with a pressing element by means of pressure on the flange and the film together.

39. The container according to claim 2, wherein during initial sealing of a filled container a circumferential, in particular, an annular pressing element, can be inserted into the lid cap or is molded thereto in one piece.

40. The container according to claim 2, wherein an outer diameter of a pressing element is substantially equal to a smallest inner diameter of a collar.

41. The container according to claim 2, wherein a radial width of a pressing element is at least equal to a radial extension of a flange of the lid ring.

42. The container according to claim 2, wherein an axial height of a pressing element is larger than the clear distance as measured in an axial direction between a bottom of an inner area of the lid cap and a top of a flange in an unstressed condition.

43. The container according to claim 2, wherein when initially sealing a filled container, a circumferential, annular pressing element can be inserted into the lid cap or is molded thereto in a material bonding manner, that has an outer diameter which is substantially equal to a smallest inner diameter of a collar, a radial width which is substantially equal to a radial extension of a flange of the lid ring, and an axial height which is larger than the clear distance between a bottom of a central part of the lid cap and a top of the flange in the sealing position to such an extent that in the sealing position the pressing element exerts an axial pre-stressing pressure on the flange and the film, at least in a section of a connecting area.

44. The container according to claim 1, wherein the lid ring in combination with the film closes a take-out opening, and is suitable for sealingly closing a chemical-technical filling fluid container.

45. The container according to claim 2, wherein the lid ring in combination with the film closes a take-out opening, and is suitable for sealingly closing a chemical-technical filling fluid container.
